(19) United States
(12) Patent Application Publication
(10) Pub. No.: US 2005/0196721 A1
(43) Pub. Date: Sep. 8, 2005

(54) Portable LED curing light

(76) Inventors: David Jackson III, Aurora, OH (US); Douglas Mansor, Tallmadge, OH (US)

Correspondence Address: KATTEN MUCHIN ROSENMAN LLP, 575 MADISON AVENUE, NEW YORK, NY, 10022-2585, US

(21) Appl. No.: 11/062,103

(22) Filed: Feb. 18, 2005

Related U.S. Application Data
(60) Provisional application No. 60/545,656, filed on Feb. 18, 2004.

(51) Int. Cl. A61C 3/00; B32B 31/16

(52) U.S. Cl. 433/29; 156/73.1; 433/77

(57) ABSTRACT

A portable LED curing light for dental applications includes a one-piece handle assembly with an angled light-producing end for positioning within a patient's mouth for curing a dental material. A replaceable lens for focusing light emitted by an LED light source is removably attached at the light-producing end. The handle also includes a battery and associated electronics for operating the light, including an operating switch, an audible indicator and at least one visual indicator. The handle is coupled with a base for storage and recharging, which positions the handle at an inclined position for draining moisture away from the handle. Circuitry in the handle monitors the status of battery voltage and handle temperature, and prevents operation of the switch from initiating a next curing cycle when battery voltage is determined to be too low or handle temperature is determined to be too high.

### CROSS-REFERENCE TO RELATED APPLICATION

The present application claims priority under 35 U.S.C.§ 119(e) from U.S. Ser. No. 60/545,656, entitled “Portable LED Curing Light,” filed on Feb. 18, 2004. U.S. Ser. No. 60/545,656 was filed by at least one inventor common to the present application, and is hereby incorporated by reference.

### FIELD OF THE INVENTION

The present invention relates to a light used for curing light-activated compound materials. In particular, the present invention relates to a portable rechargeable curing light for dental applications.

### BACKGROUND OF THE INVENTION

Light-activated compounds are well known and used in a variety of commercial applications. For example, such compounds are widely used in a variety of dental procedures including restoration work and teeth filling after root canals and other procedures requiring drilling. Several well-known dental compounds have been sold, for example, under the trade names of BRILLIANT LINE, Z-100, TPH, CHARISMA and HERCULITE & BRODIGY.

Dental compounds typically comprise liquid and powder components mixed together to form a paste. Curing of the compound requires the liquid component to evaporate, causing the composite to harden. In the past, curing has been accomplished by air drying, which has had the disadvantage of requiring significant time. This time can greatly inconvenience the patient. More recently, use of composite materials containing light-activated accelerators has become popular in the field of dentistry as a means for decreasing curing times. According to this trend, curing lights have been developed for dental curing applications. An example of such a curing light is illustrated by U.S. Pat. No. 5,975,895, issued Nov. 2, 1999 to Sullivan.

Conventional dental curing lights have employed tungsten filament halogen lamps that incorporate a filament for generating light, a reflector for directing light, and often a filter for limiting transmitted wavelengths. For example, a blue filter may be used to limit transmitted light to wavelengths in the region of 400 to 500 nanometers (nm). Light is typically directed from the filtered lamp to a light guide, which directs the light emanating from an application end of the guide to a position adjacent to the material to be cured.

Filters are generally selected in accordance with the light activation properties of selected composite compound materials. For example, blue light may be found to be effective to excite composite accelerators such as camphoroquinine, which has a blue light absorption peak of approximately 470 nanometers (nm). Once excited, the camphoroquinine accelerator in turn stimulates the production of free radicals in a tertiary amine component of the composite, causing polymerization and hardening.

A problem with conventional halogen-based lights is that the lamp, filter and reflector degrade over time. This degradation is particularly accelerated, for example, by the significant heat generated by the halogen lamp. For example, this heat may cause filters to blister and cause reflectors to discolor, leading to reductions in light output and curing effectiveness. While heat may be dissipated by adding a fan unit to the light, the fan may cause other undesired effects (for example, undesirably dispersing a bacterial aerosol that may have been applied by the dentist to the patient's mouth). Alternate lamp technologies using Xenon and other laser light sources have been investigated, but these technologies have tended to be costly, consumed large amounts of power and generated significant heat. Laser technologies have also required stringent safety precautions.

Light Emitting Diodes (LEDs) offer a good alternative to halogen curing light sources, having excellent cost and life characteristics. Generating little heat, they also present less risk of irritation or discomfort to the patient. However, in the past, LEDs have been capable of generating only modest optical power levels. As a result, many prior art curing lights have required arrays of LEDs to generate sufficient optical power levels for curing applications (see, e.g., U.S. Pat. No. 6,331,111 to Cao).

More recently, the electrical and optical power outputs for LEDs have improved substantially. For example, LEDs are currently capable of producing powers in excess of 1 watt at efficiencies in excess of 45 percent to generate more than 100 lumens per watt (see, e.g., Eric Learner, “Solid-state illumination is on the horizon, but challenges remain”, Laser Focus World, November 2002). Accordingly, it would be desirable to produce a compact, portable LED curing light for use in dental curing applications.

### SUMMARY OF THE INVENTION

A portable LED curing light is disclosed, with application to curing of dental materials and other related applications. The light includes a one-piece handle assembly including a slim probe portion with an angled light-producing end that is suitable, for example, to be positioned within a dental patient's mouth for curing a dental material positioned in a tooth of the patient. A replaceable lens for focusing light emitted by an LED light source is removably attached at the light-producing end. The handle also includes a battery and associated electronics for operating the light, including an operating switch, an audible indicator and at least one visual indicator. The handle is coupled with a base for storage and recharging of the battery. The base positions the handle at an inclined position, and provides a drain for draining moisture away from the handle.

Upon operation of the switch, the light may be operated for a predetermined curing cycle, after which power is automatically removed (“sleep mode”). An audible beep is produced at predetermined intervals during the curing cycle so that a desired curing time can be determined and achieved. Circuitry in the handle monitors the status of battery voltage and handle temperature. Based on predetermined thresholds, if either battery voltage is determined to be too low or handle temperature is determined to be too high, the circuitry prevents operation of the switch from initiating a next curing cycle. If the light is currently operating in a current curing cycle at a time at which either battery voltage is determined to be too low or handle temperature is determined to be too high, the light continues to operate through completion of the duty cycle. The visual indicator indicates when either battery voltage is determined to be too low or handle temperature is determined to be too high.

### BRIEF DESCRIPTION OF THE DRAWING

A more complete understanding of the invention may be obtained by reference to the appended drawing in which:

FIGS. 1(a)-1(f) provide orthographic and perspective views of a handle of the disclosed LED curing light;

FIG. 2 provides an exploded view of the curing light handle;

FIGS. 3(a)-3(d) provide orthographic and perspective views of a heat sink for dissipating heat in the curing light handle;

FIGS. 4(a)-4(d) provides several views of a ball lens affixed to the curing light handle for focusing light emitted by the LED;

FIG. 5 illustrated features of a left housing case of the curing light handle;

FIG. 6 illustrates features of a right housing case of the curing light handle;

FIG. 7 presents a schematic diagram of a circuit for operating the curing light handle;

FIG. 8 presents a schematic diagram of a circuit for charging a battery in the base;

FIGS. 9(a), 9(b) provides exploded views of components of a base for receiving the curing light handle; and

FIGS. 10(a)-10(g) provides orthographic and perspective views of the base;

In the various figures, like reference numerals wherever possible designate like or similar elements of the invention.

### DETAILED DESCRIPTION

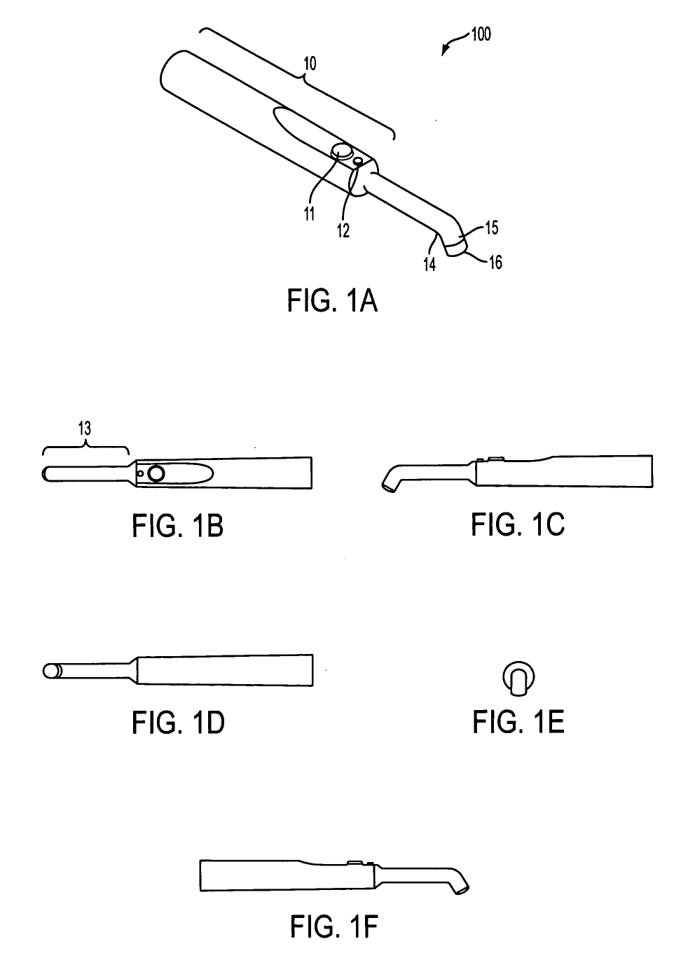

FIGS. 1(a)-1(f) present several views illustrating a handle 100 of an exemplary LED curing light embodying the principles of the present invention. FIG. 1(a) presents a perspective view of the handle 100. FIGS. 1(b) and 1(d) respectively present top and bottom elevation views of the handle 100. FIGS. 1(c) and 1(f) respectively present right side and left side views of the handle 100, and FIG. 1(e) presents a front view of the handle 100.

The handle 100 includes a gripping portion 10 for an operator to hold the handle 100. The gripping portion 10 encloses, for example, electrical circuit and battery components of the handle 100 (not shown), and provides access to a switch button cover 11 for operating the curing light. The handle 100 also houses at least one visual indicator 12 (for example, comprising an LED) for indicating a current state or status of the curing light.

Extending from the gripping portion of the handle 100 is a probe portion 13 of the handle 100 that has a diameter reduced from a diameter of the gripping portion 10, and includes an angled bend 14 near a distal end 15 of the probe portion 14 in order that the distal end 15 may be conveniently positioned, for example, within a dental patient's mouth. This configuration enables a lens assembly 16 at the distal end 15 of the probe to be placed in close proximity to a patient's tooth, so that light emitted at the distal end 15 of the probe portion 13 may be used to cure a dental material that has been applied to the tooth.

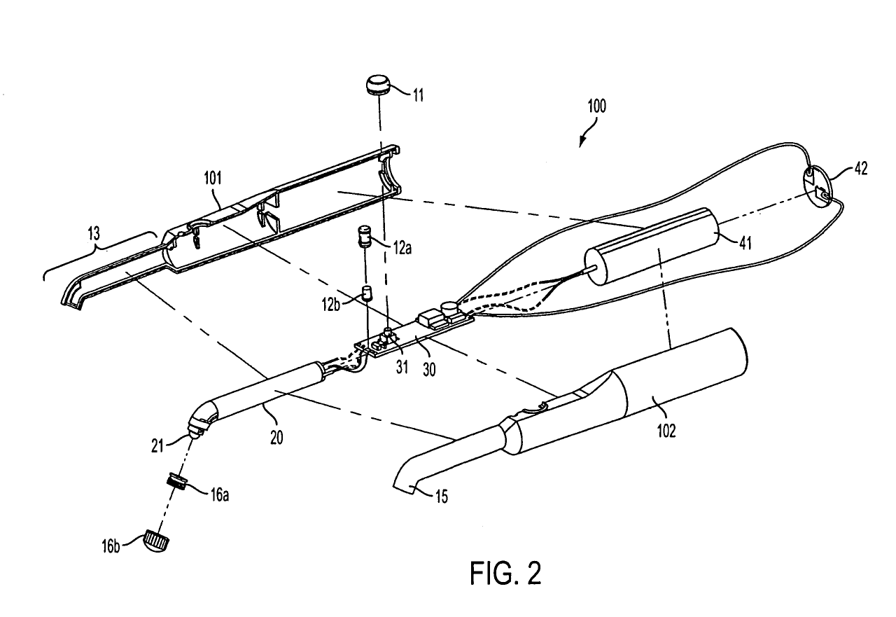

FIG. 2 provides an exploded view of the curing light handle 100, including right housing case 101, a left housing case 102, an LED/heat sink subassembly 20, and an optical choke 16a and a ball lens 16b positioned in proximity to an LED 21. The ball lens 16b is configured to be removable and replaceable. Optical choke 16a and a ball lens 16b are selected so that the LED 21 produces a focused light output at the distal end 15 of the probe portion 13. FIG. 2 also illustrates a curing light circuit board assembly 30, electrically coupled to each of the LED 21, a battery 41, and a battery charging terminal 42 of the handle 100. A switch button cover 11 made of neoprene or some like material covers an operating switch 31 mounted on the circuit board 30, and protrudes through the cases 101, 102 to provide external means for operating the curing light. An indicator cover 12a and a light pipe 12b are positioned over an indicator LED on the circuit board assembly 30. Indicator cover 12a protrudes from the circuit board assembly 30 through the cases 101, 102. Audio circuitry (not shown) for producing an audible indicator (for example, a “beep”) is also positioned on circuit board assembly 30.

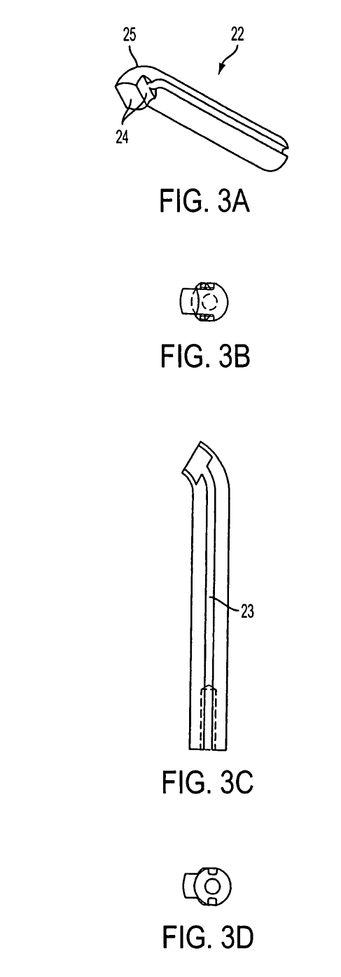

FIGS. 3(a)-3(d) present several views illustrating a heat sink 22 of the LED/heat sink subassembly 20, for dissipating heat primarily generated by the LED 21 of FIG. 2. FIG. 3(a) presents a perspective view of the heat sink 22. FIGS. 3(b) and 3(d) respectively present top and bottom elevation views of the heat sink 22, and FIG. 3(c) presents a side view of the heat sink 22.

The heat sink 22 conforms to an inner volume of the probe portion 13 of FIG. 1, and substantially fills this inner volume. Preferably formed in a single piece, it extends through the angled bend 14 of the probe portion 13 of FIG. 1 in order to be directly and thermally coupled to the LED 21 of FIG. 2. The heat sink 22 includes, for example, lateral grooves 23 on opposing sides of heat sink 22 for directing electrical wires from the LED 21 of FIG. 2 to the circuit board assembly 30 of FIG. 2. Heat sink 22 is also includes notches 24 on opposing sides of heat sink 22 at a distal end 25 of the heat sink in order to locatably couple the LED 21 at the distal end 25 The heat sink 22 preferably comprises a highly thermally conductive material such as copper 101.

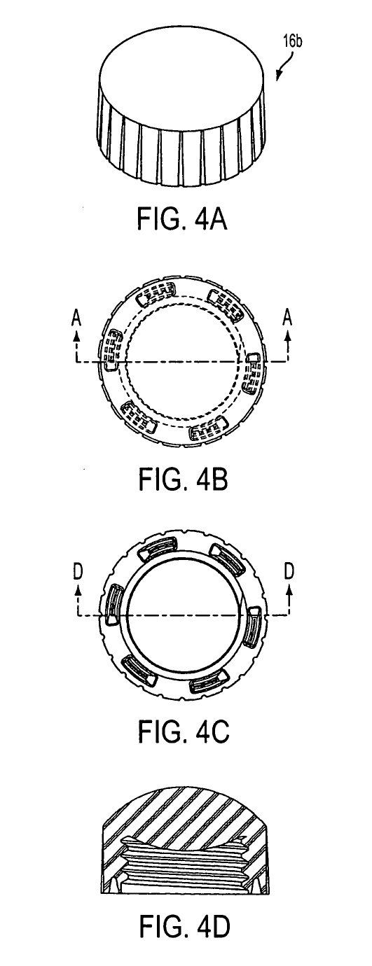

FIGS. 4(a)-4(d) provide several views of a ball lens 16b affixed to the curing light handle for focusing light emitted by the LED. FIG. 4(a) presents a perspective view of the ball lens 16b. FIGS. 4(b) and 1(c) respectively present top and bottom elevation views of the ball lens 16b, and FIG. 4(c) presents a section view through section A-A of FIG. 4(c).

The ball lens 16b, in conjunction with the optical choke 16a illustrated in FIG. 2, further focuses a light beam emitted by the LED 21 of FIG. 2. Ball lens 16b and optical choke 16a are selected so that a majority of the emitted light energy is concentrated over an area that is sufficient for curing dental composites in a patient's mouth.

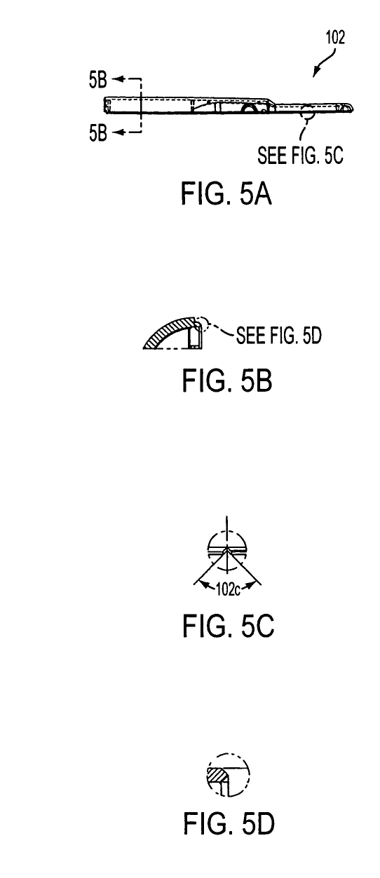

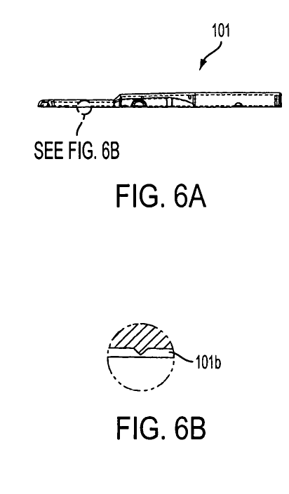

FIGS. 5(a)-5(d) and 6(a), 6(b) respectively illustrate features of left housing case 102 and a right housing case 101, respectively. The right housing case 101 and left housing case 102 may be mated for example by ultrasonic welding. An energy director 102a of the left housing case 102 includes an outwardly extending v-shaped edge 102b (see, e.g., Section F-F of FIG. 5(a), 5(b)) that may be positively located and mated to a corresponding groove (not shown) in the right housing case (see, e.g., Section B-B of FIG. 6). In addition, the v-shaped edge of the energy director is periodically relieved by an inwardly extending v-shaped groove 102c (see, e.g., Detail G of FIG. 5(c)) that in order to receive a weld lock 101b of the left housing case (see, e.g., Detail H of FIG. 6(b)). In this manner, the left housing case and right housing case can be easily, precisely and fixedly aligned for mating during the ultrasonic welding process. Once ultrasonically welded, the left housing case and right housing case form a rigid, one-piece housing for the handle.

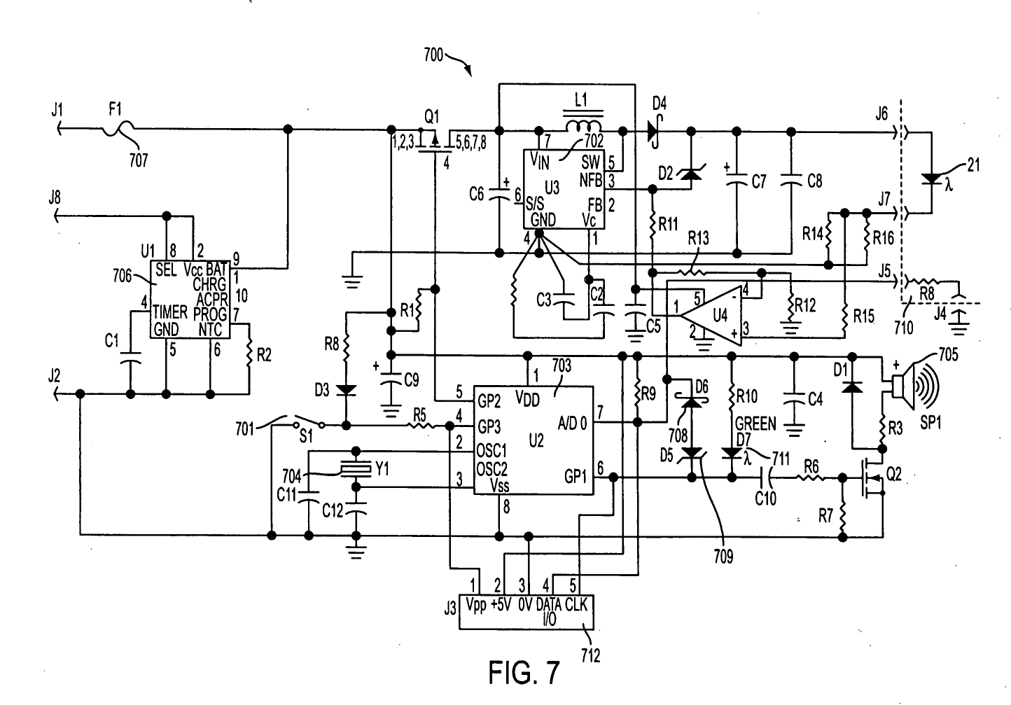

FIG. 7 presents a schematic diagram of a circuit 700 for operating the curing light handle. The circuit 700 is preferably powered by a conventional lithium battery (illustrated as battery 41 of FIG. 2), but may alternatively be powered by a conventional nickel cadmium battery, or alternatively, by a nickel metal hydride battery.

Switch 701 signals switching controller 702 via microcontroller 703 to turn on LED 21 for a predetermined curing cycle (for example, sixty seconds). Microcontroller 703 is coupled to crystal oscillator 704 to provide timed control functions. After completion of the curing cycle, microcontroller 703 removes power from LED 21 to allow the curing light to enter a sleep mode.

During operation of LED 21, microcontroller 703 periodically outputs a signal on pin 1 of microcontroller 703 (for example, every ten seconds) to cause speaker 705 to produce a regularly timed audible beep. These beeps may be used by a dentist or other operator of the handle 100 of FIG. 1 to determine an elapsed time, and thereby to apply the curing light to cure a dental material for a desired curing time. A charging circuit 706 and fuse 707 regulate battery charging and prevent the battery from being overcharged.

Microcontroller 703 is further programmed to periodically test for adequate battery voltage and excessive operating temperature (for example, every five seconds). For example, microcontroller 703 determines the adequacy of battery voltage Vdd by measuring and comparing Vdd as supplied to the circuit 700 to a fixed voltage reference measured across diodes 708, 709. Microcontroller 703 further determines operating temperature by measuring a voltage drop across a resistive component of thermistor 710 relative to Vdd. As the voltage drop across the thermistor is a function of Vdd, a dimensionless ratio of these two voltages may be produced to determine a relative measure of operating temperature.

If either battery voltage is determined to be inadequate and/or operating temperature is determined to be excessive, microcontroller 703 does not permit a new operating cycle to begin in response to an operation of switch 701. If an operating cycle is in progress when battery voltage is determined to be inadequate and/or operating temperature is determined to be excessive, microcontroller 703 allows the currently operating cycle to complete before preventing initiation of subsequent operating cycles. While battery voltage and operating temperature are at proper levels for operation, microcontroller 703 controls a voltage at pin 6 to light indicating LED 711.

In order to provide for change and upgrading of its operating program, microcontroller 703 may further be coupled to programming connector 712.

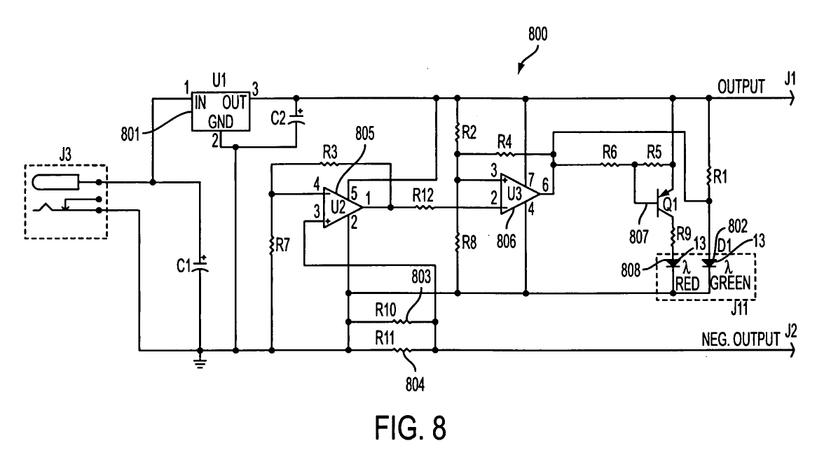

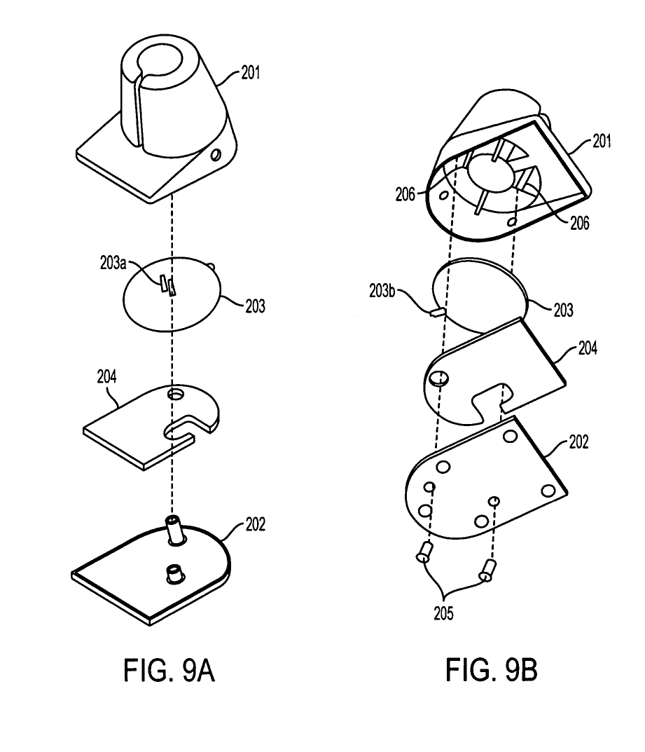

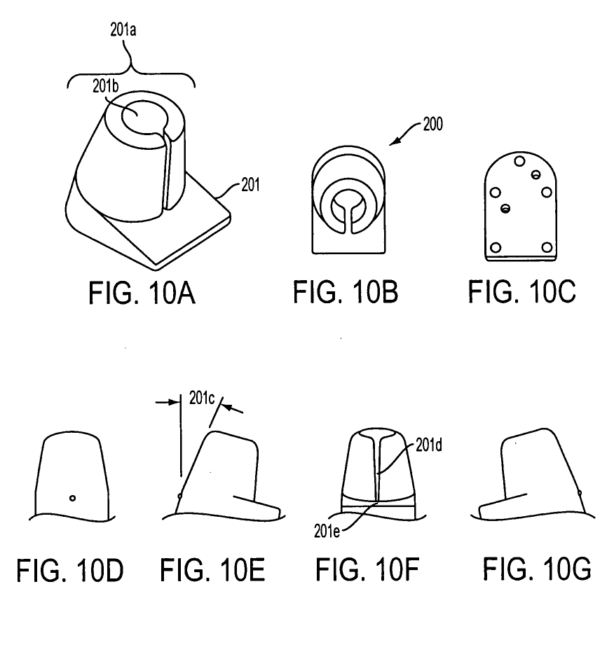

FIG. 8 presents a schematic diagram of a charging circuit 800 for charging battery 41 of FIG. 2 by means of base 200 of FIGS. 9, 10. As illustrated in FIG. 8, linear regulator 801 regulates a voltage supplied to the charging circuit 800 (for example, from a commercial power source). So long as adequate commercial power is supplied, green LED 802 lights to provide an indication that commercial power is present. As significant current is drawn at lead J2 for recharging the battery, a voltage drop across resistors 803, 804 activates amplifiers 805, 806 to cause current flow through transistor 807 in order to light the red LED 808 to indicate that the battery is recharging.

FIGS. 9(a), 9(b) respectively provide exploded views of components of a base 200 for receiving the curing light handle from above and below the base 200. The components of base 200 include a main housing 201, a lower housing 202, a circuit board 203 including a battery charger pin assembly 203a and a power receptacle 203b, and a weight 204 for stabilizing the circuit board. FIG. 10 provides orthographic and perspective views of the base. The components 201-204 may be assembled together using a variety of conventional fastening means (for example, by means of retaining pins 205 which may be ultrasonically welded, glued or thread mounted to receptacles 206.

FIGS. 10(a)-10(g) further illustrate the base 200. FIG. 10(a) presents a perspective view of the base 200. FIGS. 10(b) and 10(c) respectively present top and bottom elevation views of the base 200. FIGS. 10(e) and 10(g) respectively present right side and left side views of the base 200. FIG. 10(f) presents a front view of the base 200, and FIG. 10(g) provides a rear view of the base 200.

Main housing 201 includes a conical portion 201a having a recess 201b for receiving the gripping portion of the handle for storage and re-charging of the handle. The conical portion 201a and recess 201b are co-axially oriented slightly away from a vertical angle 201c (for example, approximately 10 to 15 degrees). A slit 201d extends through the conical 201a portion into the recess 201b, and terminates at a lowest portion 201e of a base of the conical portion 201a in order to enable moisture collecting within the interior of the recess 201b to drain away through the slit. At least two charging pins in charging pin assembly 203a of FIG. 9 extend upward from the recess near the base of the conical portion 201a for contact with battery charging terminal 42 of FIG. 2 at the of handle 100. The charging terminal 42 includes at least two, electrically isolated conductive rings (not shown). When the handle is inserted into the recess, each pin makes electrical contact with one of the conductive rings, regardless of the radial orientation of the handle in the recess.

Appendix 1 provides a program listing illustrating for example the manner in which microcontroller U2 of FIG. 7 is operated to measure battery voltage and thermistor temperature, and therefrom to control operation of the curing cycle and lighting of the visual status indicator.

The foregoing describes the invention in terms of embodiments foreseen by the inventor for which an enabling description was available, notwithstanding that insubstantial modifications of the invention, not presently foreseen, may nonetheless represent equivalents thereto.

APPENDIX 1
;**********************************************************************
; Program for the LED curing light *
; Microcontroller used is the 8 pin PIC12F675. *
; *
;**********************************************************************
; *

| | |
|---|---|
| ; Filename: | LEDcure_Vx.asm |
| * | |

| | |
|---|---|
| ; Date: | February 20, 2003 * |
| ; File Version: | 03032716 (YYMMDDHH) * |

; *

| | |
|---|---|
| ; Author: | Douglas J. Mansor * |
| ; Company: | Coltene/Whaledent, Inc. * |

; *
; *
;**********************************************************************
; *

| | |
|---|---|
| ; Files required: | p12f675.inc * |

; *
; *
; *
;**********************************************************************
; *
; Notes: *
; *
; *
; *
; *
;**********************************************************************
;

| | | |
|---|---|---|
| list | p=12f675 | ; list directive to define processor |
| #include | <p12f675.inc> | ; processor specific variable |
| definitions | | |
| ; | | |

| | |
|---|---|
| errorlevel −302 | ; suppress message 302 from list |
| file | |
| ; | |

_{——}CONFIG _CP_ON & _WDT_OFF & _MCLRE_OFF & _PWRTE_OFF & _LP_OSC &
_BODEN_OFF
; ‘_{——}CONFIG’ directive is used to embed configuration word within .asm
file.
; The lables following the directive are located in the respective .inc
file.
; See data sheet for additional information on configuration word
settings.
;
;
;***** VARIABLE DEFINITIONS

| | | | |
|---|---|---|---|
| w_temp | EQU | 0x50 | ; variable used for context |
| saving | | | |

| | | | |
|---|---|---|---|
| status_temp | EQU | 0x51 | ; variable used for context saving |
| ; | | | |
| STATE | EQU | 0x20 | ;STATE machine indicator |

| | | | |
|---|---|---|---|
| OVERTEMP | EQU | H‘0000’ | ;Hot bit in STATE |
| UNDERVOLTAGE | EQU | H‘0001’ | ;Low voltage bit in STATE |

| | | | |
|---|---|---|---|
| LIGHTON | EQU | H‘0002’ | ;Light on bit in STATE |
| ; | | | |

| | | | |
|---|---|---|---|
| TIME | EQU | 0x21 | ;Timer overflow count, 10s count |
| THERH | EQU | 0x22 | ;High temperature byte |
| THERL | EQU | 0x23 | ;Low temperature byte |
| VOFFH | EQU | 0x24 | ;Battery voltage with light off, |
| high byte | | | |
| VOFFL | EQU | 0x25 | ;Battery voltage with light off, low |
| byte | | | |
| VONH | EQU | 0x26 | ;Battery voltage with light on, high |
| byte | | | |
| VONL | EQU | 0x27 | ;Battery voltage with light on, low |
| byte | | | |

| | | | |
|---|---|---|---|
| ACCUMH | EQU | 0x30 | ;Accumulator, high byte |
| ACCUML | EQU | 0x31 | ;Accumulator, low byte |
| ACCUMB | EQU | 0x32 | ;Accumulator B. Counts cycles |
| of beep. | | | |

| | | | |
|---|---|---|---|
| TEMP1 | EQU | 0x33 | ;Temporary register storage 1 |
| TEMP2 | EQU | 0x34 | ;Temporary register storage 2 |
| LOOPCTR1 | EQU | 0x35 | ;For counting Mainloops |
| LOOPCTR2 | EQU | 0x36 | ;For counting loops |
| VMINL | EQU | 0x80 | ;coresponds to 3.5V with 1.44V Ref. |
| LOOPS | EQU | 0x20 | ;delay 32 × 256 loops |

| | | | |
|---|---|---|---|
| TENS | EQU | 0x6 | ;Light ON time in 10s |
| intervals | | | |

| | | | |
|---|---|---|---|
| SEC5 | EQU | 0x5F | ;for 5s timing. 32768kHz osc = |
| 122.07us cyc | | | |

| | |
|---|---|
| ; | 256 * 160 * 122.07031us |
| = 5s, 160d = A0h | |
| ; | FFh − A0h = 5Fh |

| | | | |
|---|---|---|---|
| TMR1SETH | EQU | 0D7h | ;The high byte of timer1 preset for |
| 10s | | | |
| TMR1SETL | EQU | 0FFh | ;The low byte of timer1 preset for |
| 10s | | | |

; for prescaler = 1:8 and Fosc = 32768 Hz
;
;
;**********************************************************************

| | | | |
|---|---|---|---|
| | ORG | 0x000 | ; processor reset vector |
| | goto | main | ; go to beginning of program |
| ; | | | |
| ; | | | |
| | ORG | 0x004 | ; interrupt vector location |
| | movwf | w_temp | ; save off current W register |

contents

| | | |
|---|---|---|
| movf | STATUS,w | ; move status register into W |

register

| | | |
|---|---|---|
| movwf | status_temp | ; save off contents of STATUS |

register
;
;
; INTERRUPT code can go here or be located as a call subroutine
elsewhere
;_{———————————————}

| | | |
|---|---|---|
| clrf | PIR1 | ;Clear IRQ flags |
| movlw | 0C0h | ;Enable peripheral IRQs |
| movwf | INTCON | ;& disable Timer 0 IRQ and |

external IRQ
; Verify STATE

| | | |
|---|---|---|
| btfsc | STATE,LIGHTON | ;Is the Light on? |

| | | |
|---|---|---|
| goto | IRQ_ok | ;The light is on and being |

timed

| | | |
|---|---|---|
| call | stopall | ;The Timer isn't supposed to |

be running!

| | | |
|---|---|---|
| goto | IRQ_return | ;stop it and exit IRQ |

IRQ_ok:

| | | |
|---|---|---|
| movlw | TMR1SETH | ;load with 10240 counts at 976.562us |
| movwf | TMR1H | ;before next IRQ |
| movlw | TMR1SETL | |
| movwf | TMR1L | |

| | | |
|---|---|---|
| decfsz | TIME,1 | ;bump 60s time keeper |

| | |
|---|---|
| goto | not60yet |

; Maximum on time has been reached.

| | | |
|---|---|---|
| call | stopall | ;subroutine to turn off big |

LED and stop timer
not60yet:

| | | |
|---|---|---|
| call | beepone | ;execute a beep |

| | | |
|---|---|---|
| bcf | PIR1,TMR1IF | ;Clear the Timer 1 IRQ flag |

;
IRQ_return:
;_{———————————————}

| | | |
|---|---|---|
| movf | status_temp,w | ; retrieve copy of STATUS register |
| movwf | STATUS | ; restore pre-isr STATUS register |

contents

| | | |
|---|---|---|
| swapf | w_temp,f | |
| swapf | w_temp,w | ; restore pre-isr W register |

contents

| | |
|---|---|
| retfie | ; return from interrupt |

;
main:
;
;----------INITIALIZE-------------
; setup GPIO, 2,3 (pins 5,4) as input,
; 0,1,4,5 (pins 7,6,3,2) as output,
; analog mode off

| | | |
|---|---|---|
| bcf | STATUS, RP0 | ;Bank 0 |

| | | |
|---|---|---|
| clrf | GPIO | ;Init GPIO |

| | | |
|---|---|---|
| movlw | 07h | ;Set GP<2:0> to |

| | | |
|---|---|---|
| movwf | CMCON | ;digital I0 (Turn off the |

comparator)

| | | |
|---|---|---|
| bsf | STATUS, RP0 | ;Bank 1 |

| | | |
|---|---|---|
| movlw | 039h | ;Set GP<5:4:3:0> as inputs (0=out, |

1=in)

| | | |
|---|---|---|
| movwf | TRISIO | ;and set GP<2:1> as outputs |
| movlw | 00h | ;Don't turn on any weak |

pullups

| | | |
|---|---|---|
| movwf | WPU | ;GP3 doesn't have a pullup |

| | |
|---|---|
| clrwdt | ;Clear the doggie |

| | | |
|---|---|---|
| movlw | 87h | ;Disable weak pullups and GP2 |

not clk source

| | | |
|---|---|---|
| movwf | OPTION_REG | ;setup OPTION register. Enable |

Timer0 & /256

| | | |
|---|---|---|
| clrf | IOCB | ;Disable Interrupts for input |

changes

| | | |
|---|---|---|
| movlw | 01h | ;Enable A/D 0 (pin7) & A/D |

clock = Fosc/2

| | | |
|---|---|---|
| movwf | ANSEL | ;Disable the other A/D inputs |
| movlw | 01h | |
| movwf | PIE1 | ;Enable timer 1 overflow interrupt |

| | | |
|---|---|---|
| bcf | STATUS, RP0 | ;Bank 0 |

| | | |
|---|---|---|
| bsf | GPIO,2 | ;turn on the weak pullup |

for GP2

| | | |
|---|---|---|
| movlw | 81h | ;Right justify output, Vdd = |

REF

| | | |
|---|---|---|
| movwf | ADCON0 | ;select AD0, Turn on A/D power |

| | | |
|---|---|---|
| movlw | 0C0h | ;Enable peripheral IRQs |

| | | |
|---|---|---|
| movwf | INTCON | ;& disable Timer 0 IRQ and |

| | |
|---|---|
| external IRQ | |
| ; | and port change |
| IRQ | |

| | | |
|---|---|---|
| clrf | PIR1 | ;Clear IRQ flags |
| clrf | TMR1L | |
| clrf | TMR1H | |

| | | |
|---|---|---|
| movlw | 31h | ;1:8 prescale, timer 1 ON |

| | | |
|---|---|---|
| movwf | T1CON | ;and timer 1 gate enabled |
| clrf | STATE | |
| clrf | TIME | |

;
;
beginhere:
; This is where the program will actually start.
; Some setup items will occur before getting into the main loop
;
; Clear first half of RAM (Should disable IRQ first?-----------)

| | | |
|---|---|---|
| movlw | 20h | ;initialize pointer |
| movwf | FSR | ;to point at RAM |

| | | |
|---|---|---|
| NEXT: clrf | INDF | ;clear the INDF register |

| | | |
|---|---|---|
| incf | FSR,1 | ;increment the pointer |
| btfss | FSR,6 | ;maybe done? |
| goto | NEXT | ;no, keep at it |

| | | |
|---|---|---|
| bsf | GPIO,1 | ;Green off |
| bsf | GPIO,2 | ;big LED off |

| | | | |
|---|---|---|---|
| ; | movlw | LOOPS | ;reset the loop counter |
| ; | movwf | LOOPCTR2 | ;to “LOOPS” value |

; Setup Timer 0 for Temperature and voltage checking

| | | |
|---|---|---|
| movlw | SEC5 | ;get the preset value |
| movwf | TMR0 | ;into timer 0 |

;
Mainloop:

| | | |
|---|---|---|
| btfss | GPIO,3 | ;test GP3 for a low condition |

(pin 4)

| | | |
|---|---|---|
| goto | buttondown | ;perform button down sequence |

| | | | |
|---|---|---|---|
| ; | incfsz | LOOPCTR1,1 | ;don't check temp & Vcc very |
| often | | | |

| | | | |
|---|---|---|---|
| ; | goto | Mainloop | ;delay 256 loops (might need more) |

| | | | |
|---|---|---|---|
| ; | decfsz | LOOPCTR2,1 | ;delay up to 65768 loops |
| ; | goto | Mainloop | ;more loops |
| ; | movlw | LOOPS | ;reset the loop counter |
| ; | movwf | LOOPCTR2 | ;to “LOOPS” value |

; Check the 5 second timer for Temperature and voltage checking

| | | |
|---|---|---|
| movf | TMR0,0 | ;Get the current timer 0 value |
| addlw | 1 | ;bump the count to get off |

dead center

| | | |
|---|---|---|
| sublw | SEC5 | ;SEC5-TMR0. sets carry unless |

overflow

| | | |
|---|---|---|
| btfss | STATUS,C | ;skip next if no carry (carry; C = |

0)

| | | |
|---|---|---|
| goto | Mainloop | ;go loopy |
| movlw | SEC5 | ;get the preset value |
| movwf | TMR0 | ;into timer 0 |

| | | |
|---|---|---|
| ; | clrwdt | ;Clear the prescaler |

; Test T & V

| | | |
|---|---|---|
| btfsc | STATE,LIGHTON | ;check if light is on |
| goto | lightison | |
| call | convert1_off | ;since light is off, read off |

battery voltage
; Test that battery voltage is high enough

| | | |
|---|---|---|
| btfsc | VOFFH,1 | ;Test bit 1 of off voltage. |

high = battery too low

| | | |
|---|---|---|
| goto | low_battery | ;flag the low battery signal |

| | | |
|---|---|---|
| btfss | VOFFH,0 | ;check the 0 bit of off |

voltage. 0 = high volts

| | | |
|---|---|---|
| goto | high_batt | ;if bit 0 = 1, must test the low |

byte

| | | |
|---|---|---|
| movlw | VMINL | ;get the minimum Vcc limit |

| | | |
|---|---|---|
| subwf | VOFFL,0 | ;compare with the minimum |

acceptable voltage

| | | |
|---|---|---|
| btfsc | STATUS,C | ;if C = 0 then voltage is OK |
| goto | low_battery | |

high_batt:

| ;clear the low battery flag and light green light | | |
|---|---|---|
| bcf | STATE,UNDERVOLTAGE | ;voltage OK |

| | |
|---|---|
| goto | Mainloopskp1 |

low_battery:

| | | |
|---|---|---|
| bsf | STATE,UNDERVOLTAGE | ;voltage too low |

| | |
|---|---|
| goto | Mainloopskp1 |

lightison:

| | | |
|---|---|---|
| call | convert1_on | ;read light-on battery voltage |

; Test that battery voltage is high enough

| | | |
|---|---|---|
| btfsc | VONH,1 | ;Test bit 1 of on voltage. |

high = battery too low

| | | |
|---|---|---|
| goto | low_battery | ;flag the low battery signal |

| | | |
|---|---|---|
| btfss | VONH,0 | ;check the 0 bit of on |

voltage. 0 = high volts

| | | |
|---|---|---|
| goto | high_batt | ;if bit 0 = 1, must test the low |

byte

| | | |
|---|---|---|
| movlw | VMINL | ;Get the minimum Vcc limit |

| | | |
|---|---|---|
| subwf | VONL,0 | ;compare with the minimum |

acceptable voltage

| | | |
|---|---|---|
| btfsc | STATUS,C | ;if C = 0 then voltage is OK |
| goto | low_battery | ;If low |
| goto | high_batt | ;If high |

Mainloopskp1:
; Check diode temperature

| | | |
|---|---|---|
| call | convert0 | ;read temperature |
| call | Checkstate | |
| goto | Mainloop | |

buttondown:

| | | |
|---|---|---|
| btfsc | GPIO,3 | ;is the button still down? |

| | | |
|---|---|---|
| goto | Mainloop | ;if not down |

| | | |
|---|---|---|
| btfsc | GPIO,3 | ;check button a third time |

| | | |
|---|---|---|
| goto | Mainloop | ;if not still down |

; Only turn on the big LED if STATE = 0

| | | |
|---|---|---|
| clrw | | |
| iorwf | STATE,0 | ;check if STATE = 0 |

| | | |
|---|---|---|
| btfsc | STATUS,Z | ;zero flag is 0 if STATE /= 0 |

| | | |
|---|---|---|
| goto | turnon | ;go turn on the big LED |

| | | |
|---|---|---|
| btfss | STATE,LIGHTON | ;is the big LED on? |
| goto | release_wait | ;if not, can't turn it on |

; Turn off the big LED

| | | |
|---|---|---|
| call | stopall | ;lights off,timer stop, flags |

clear

| | |
|---|---|
| goto | release_wait |

turnon:

| | | |
|---|---|---|
| bcf | GPIO,2 | ;turn on the big LED |

| | | |
|---|---|---|
| bsf | STATE,LIGHTON | ;set the LED ON flag |

; Start TIMER 1

| | | |
|---|---|---|
| movlw | TMR1SETH | ;load with 10240 counts at 976.562us |
| movwf | TMR1H | ;before next IRQ |
| movlw | TMR1SETL | |
| movwf | TMR1L | |
| movlw | TENS | ;prep TIME for count of 10s periods |
| movwf | TIME | ;set the time counter |

| | | |
|---|---|---|
| bcf | PIR1,TMR1IF | ;clear any pending IRQ flag |

from timer 1

| | | |
|---|---|---|
| bsf | STATUS, RP0 | ;Bank 1 |
| bsf | PIE1, TMR1IE | ;be sure timer 1 IRQ is |

enabled

| | | |
|---|---|---|
| bsf | INTCON,GIE | ;global IRQ enabled |
| bsf | INTCON,PEIE | ;peripherial IRQ enabled |
| bcf | STATUS, RP0 | ;Bank 0 |
| bsf | T1CON,TMR1ON | ;enable timer |

| | | | |
|---|---|---|---|
| ; | movlw | LOOPS | ;reset the loop counter |
| ; | movwf | LOOPCTR2 | ;to “LOOPS” value |
| ; | clrf | LOOPCTR1 | ;To count idle loops & sync w/beeps |

; Synchronize the 5 second timer

| | | |
|---|---|---|
| movlw | SEC5 | ;get the preset value |
| movwf | TMR0 | ;into timer 0 |

| | |
|---|---|
| clrwdt | ;Clear the prescaler |

| | | |
|---|---|---|
| call | beepone | ;execute a beep |

;
release_wait:

| | | |
|---|---|---|
| btfss | GPIO,3 | ;test GP3 for high |

| | | |
|---|---|---|
| goto | release_wait | ;loop if still low |

| | | |
|---|---|---|
| btfss | GPIO,3 | ;test GP3 for high |

| | | |
|---|---|---|
| goto | release_wait | ;loop if still low |

| | | |
|---|---|---|
| btfss | GPIO,3 | ;test GP3 for high |

| | | |
|---|---|---|
| goto | release_wait | ;loop if still low |
| goto | Mainloop | ;go back to main looping when |

released
;
loophere:

| | | |
|---|---|---|
| goto | loophere | ;Tightloop, wait for reset or IRQ |

;
;
; --------SUBROUTINES------------
beepone:

| | | |
|---|---|---|
| clrf | ACCUMB | ;Clear the LS count location |

beeploop:

| | | |
|---|---|---|
| bsf | GPIO,1 | ;1 start by pulling the |

line high

| | | |
|---|---|---|
| bcf | GPIO,1 | ;1 clear the output |

| | | |
|---|---|---|
| decfsz | ACCUMB,1 | ;1 bump the counter and test, |

skip if zero

| | | | |
|---|---|---|---|
| | goto | beeploop | ;2 keep at it |
| ; | call | convert1_on | ;read Vcc with light on |

| | | |
|---|---|---|
| bsf | GPIO,1 | ;Green off |

| | | |
|---|---|---|
| call | Checkstate | ;control the green LED state |

; reset the 5 second timer before it goes off

| | | |
|---|---|---|
| movlw | SEC5 | ;get the preset value |
| movwf | TMR0 | ;into timer 0 |

| | | |
|---|---|---|
| ; | clrwdt | ;Clear the prescaler |
| ; | | |

| | | | |
|---|---|---|---|
| ; | movlw | LOOPS | ;reset the loop counter |
| ; | movwf | LOOPCTR2 | ;to “LOOPS” value |
| ; | clrf | LOOPCTR1 | ;To count idle loops & sync w/beeps |

| | |
|---|---|
| return | ; when done 255 cycles |

* 7 inst cycles = .218s
;
convert0:
; A/D conversion on input AD0 to measure temperature of thermistor
; Result is left in ADRESH and ADRESL

| | | |
|---|---|---|
| bcf | GPIO,1 | ;pull the other side of |

| | |
|---|---|
| the reference low | |
| ; | lights the green LED |
| also | |

| | | |
|---|---|---|
| bsf | ADCON0,1 | ;Start the conversion |

convert0_wait:

| | | |
|---|---|---|
| btfsc | ADCON0,1 | ;check for done |
| goto | convert0_wait | ;keep checking til done |
| call | Checkstate | ;control the green LED state |
| movf | ADRESH,0 | ;Save temperature in THERH, THERL |
| movwf | THERH | |

| | | |
|---|---|---|
| bsf | STATUS, RP0 | ;Bank 1 |

| | |
|---|---|
| movf | ADRESL,0 |
| movwf | THERL |

| | | |
|---|---|---|
| bcf | STATUS, RP0 | ;Bank 0 |

| | | |
|---|---|---|
| btfss | THERH,0 | ;check for overtemp (>90C) |

| | | |
|---|---|---|
| bsf | STATE,0 | ;set over temperature |

flag if maybe high

| | | |
|---|---|---|
| btfsc | THERH,1 | ;check high order bit |

| | | |
|---|---|---|
| bcf | STATE,0 | ;clear over temperature |

flag if sure heat is OK

| | |
|---|---|
| return | ;when done |

;
;
;
convert1_off:
; A/D conversion on input AD1 to measure battery voltage
; with the light off.
; Result is left in VOFFH and VOFFL

| | | |
|---|---|---|
| bsf | STATUS, RP0 | ;Bank 1 |
| bsf | TRISIO,1 | ;Change GP/AD1 from output to |

input (pin 6)

| | | |
|---|---|---|
| bsf | ANSEL,ANS1 | ;make AD1 active |
| bcf | TRISIO,0 | ;change GP0 (pin 7) from input |

to output

| | | |
|---|---|---|
| bcf | STATUS, RP0 | ;Bank 0 |

| | | |
|---|---|---|
| bcf | GPIO,0 | ;pull pin 7 low (GP0) |

| | | |
|---|---|---|
| bsf | ADCON0,CHS0 | ;select pin 6, AD1 for |

conversion

| | | |
|---|---|---|
| bsf | ADCON0,GO | ;Start the conversion |

convert1_off_wait:

| | | |
|---|---|---|
| btfsc | ADCON0,NOT_DONE | ;check for done |

| | | |
|---|---|---|
| goto | convert1_off_wait | ;keep checking til done |
| movf | ADRESH,0 | ;Save temperature in THERH, THERL |
| movwf | VOFFH | ;get the high bits |

| | | |
|---|---|---|
| bsf | STATUS, RP0 | ;Bank 1 |

| | | |
|---|---|---|
| movf | ADRESL,0 | ;A/D low byte and TRISIO are in bank |

1

| | | |
|---|---|---|
| movwf | VOFFL | ;get the low byte |

| | | |
|---|---|---|
| bcf | TRISIO,1 | ;change pin 6 back to output |
| bsf | TRISIO,0 | ;change GP0 (pin 7) back to |

input

| | | |
|---|---|---|
| bcf | ANSEL,ANS1 | ;inactivate AD1 |
| bcf | STATUS, RP0 | ;Bank 0 |
| bcf | ADCON0,CHS0 | ;reselect AD0 |

| | |
|---|---|
| return | ;when done |

;
convert1_on:
; A/D conversion on input AD1 to measure battery voltage
; with the light on.
; Result is left in VONH and VONL

| | | |
|---|---|---|
| bsf | STATUS, RP0 | ;Bank 1 |
| bsf | TRISIO,1 | ;Change GP/AD1 from output to |

input(pin 6)

| | | |
|---|---|---|
| bcf | TRISIO,0 | ;change GP0 (pin 7) from input |

to output

| | | |
|---|---|---|
| bsf | ANSEL,ANS1 | ;make AD1 active |
| bcf | STATUS, RP0 | ;Bank 0 |

| | | |
|---|---|---|
| bcf | GPIO,0 | ;pull pin 7 low (GP0) |

| | | |
|---|---|---|
| bsf | ADCON0,CHS0 | ;select pin 6, AD1 for |

conversion

| | | |
|---|---|---|
| bsf | ADCON0,GO | ;Start the conversion |

convert1_on_wait:

| | | |
|---|---|---|
| btfsc | ADCON0,NOT_DONE | ;check for done |
| goto | convert1_on_wait | ;keep checking til done |
| movf | ADRESH,0 | ;Save temperature in VONH, VONL |
| movwf | VONH | |

| | | |
|---|---|---|
| bsf | STATUS, RP0 | ;Bank 1 |

| | |
|---|---|
| movf | ADRESL,0 |
| movwf | VONL |

| | | |
|---|---|---|
| bcf | TRISIO,1 | ;change pin 6 back to output |
| bsf | TRISIO,0 | ;change GP0 (pin 7) back to |

input

| | | |
|---|---|---|
| bcf | ANSEL,ANS1 | ;inactivate AD1 |
| bcf | STATUS, RP0 | ;Bank 0 |
| bcf | ADCON0,CHS0 | ;reselect AD0 |

| | |
|---|---|
| return | ;when done |

;
;
Checkstate:

| | | |
|---|---|---|
| bcf | TEMP1,1 | ;default to green-on. |

| | | |
|---|---|---|
| btfsc | STATE,OVERTEMP | ;is diode too hot? |

| | | |
|---|---|---|
| bsf | TEMP1,1 | ;green-off if hot. |

| | | |
|---|---|---|
| btfsc | STATE,UNDERVOLTAGE | ;is battery too low? |

| | | |
|---|---|---|
| bsf | TEMP1,1 | ;green-off if battery is |

low.

| | |
|---|---|
| btfsc | TEMP1,1 |
| goto | CKstate_set |

| | | |
|---|---|---|
| bcf | GPIO,1 | ;Green on |

| | |
|---|---|
| goto | CKstate_done |

CKstate_set:

| | | |
|---|---|---|
| bsf | GPIO,1 | ;Green Off |

CKstate_done:

return

;
;
stopall:
; Turn off the big LED

| | | |
|---|---|---|
| bsf | GPIO,2 | ;turn big LED off |

; Stop Timer 1

| | | |
|---|---|---|
| bcf | T1CON,TMR1ON | ;stop timer 1 |
| bcf | PIR1,TMR1IF | ;clear the IRQ flag |

;

| | | |
|---|---|---|
| bcf | STATE,LIGHTON | ;clear the LED ON flag |

| | | |
|---|---|---|
| call | Checkstate | ;set/reset the green LED |

| | | |
|---|---|---|
| call | beepone | ;execute a beep |

return

;
;

| | |
|---|---|
| END | ;directive ‘end of |

program’

1. A portable curing light for dental applications, comprising:
a grippable handle;
a lens assembly mounted at a distal end of a probe portion of the grippable handle;
a light source positioned in proximity to the lens assembly, said light source including only one light emitting diode (LED);
a switch, said switch being operable at the grippable handle;
an operating circuit mounted within the grippable handle, said operating circuit being responsive to said switch for initiating a curing cycle of the portable curing light; and
a battery mounted within the grippable handle for providing power to the operating circuit for powering the light source during the curing cycle;
wherein the probe portion of the grippable handle has a first length and a first diameter that is reduced from a second diameter of a grippable portion of the grippable handle, and bends at a predetermined angle near the distal end, wherein the first length, first diameter and predetermined angle are selected for positioning the distal end in proximity to a dental material to be cured in a patient's mouth.

2. The portable curing light of claim 1, further comprising:
a heat sink directly for dissipating heat, said heat sink directly mounting the LED and substantially filling an inner cavity of the probe portion and including a bent portion bent at the predetermined angle.

3. The portable curing light of claim 1, wherein the lens assembly includes a ball lens.

4. The portable curing light of claim 1, wherein a lens of the lens assembly is removable.

5. The portable curing light of claim 3, wherein the lens assembly further includes an optical choke positioned between the ball lens and the LED.

6. The portable curing light of claim 1, wherein the ball lens is replaceably mounted at the distal end of the probe portion.

7. The portable curing light of claim 1, further comprising:
a base unit for receiving the portable curing light, the base unit including:
a main housing having a conical portion with a recess for receiving the grippable handle and a vertical slit that opens said recess to an exterior of the conical portion, said recess having a base portion that is positioned at a second predetermined angle from the horizontal plane and a longitudinal axis that is perpendicular to the base portion, and said vertical slit being positioned to terminate at a lowest point of said base portion.

8. The portable curing light of claim 7, wherein said base unit further includes:
a pin assembly for electrically contacting a battery charging terminal at a base of the grippable handle, and
a power receptacle for conducting power from an external power source to the pin assembly.

9. The portable curing light of claim 2, wherein said heat sink comprises a metallic conductor formed in a single piece.

10. The portable curing light of claim 9, wherein said heat sink further comprises one or more lateral grooves on one or more sides of said heat sink for directing electrical wires between said LED and said operating circuit.

11. The portable curing light of claim 1, wherein said operating circuit operates to activate at least one visual indicator, said at least one visual indicator indicating at least one of an adequate power level for said battery and a condition of charging said battery.

12. A method for ultrasonically welding a mating pair of plastic housings, the method comprising the steps of:
providing a mating edge of a first housing in the pair of plastic housings with an ultrasonic energy director, said ultrasonic energy director having an outwardly extending v-shaped edge along said mating edge of said first plastic housing;
providing a mating edge of a second housing in the pair of plastic housings with an inwardly-extending v-shaped groove along said mating edge of said second housing;
periodically relieving said v-shaped edge along said mating edge of said first plastic housing with a v-shaped groove positioned across said mating edge of said first plastic housing;
periodically adding an outwardly extending v-shaped edge across said inwardly-extending v-shaped groove along said mating edge of said second housing; and
mating said first and said second housings, such that said outwardly extending v-shaped edge along said mating edge of said first plastic housing mates with said inwardly-extending v-shaped groove along said mating edge of said second housing, and one or more of said periodic v-shaped grooves across said mating edge of said first plastic housing mate with one or more of said periodic v-shaped edges across said mating edge of said second plastic housing.

13. The method of claim 12, further comprising the step of:
ultrasonically welding said mating edge of said first plastic housing to said mating edge of said second plastic housing.

14. A method for controlling the operation of a dental curing light, the method comprising the steps of:
monitoring a battery voltage of the dental curing light;
monitoring an operating temperature of the dental curing light;
comparing a value of the monitored battery voltage to a first threshold value;
comparing a value the monitored operating temperature to a second threshold value;
determining whether the dental curing light is currently operating in an a curing cycle; and
while the dental curing light is not operating in a current curing cycle, preventing initiation of a next curing cycle if at least one of the monitored battery voltage and operating temperature values exceeds its associated threshold value.

15. The method of claim 14, further comprising the step of:
producing one or more audible signals at periodic intervals while the dental curing light is operating in the current curing cycle.

16. A base unit for storing a portable curing light, the base unit including:
a main housing having a conical portion with a recess for receiving the portable curing light and a vertical slit that opens said recess to an exterior of the conical portion, said recess having a base portion that is positioned at a predetermined angle from the horizontal plane and a longitudinal axis that is perpendicular to the base portion, and said vertical slit being positioned to terminate at a lowest point of said base portion.
